(19) United States
(12) Patent Application Publication
(10) Pub. No.: US 2026/0172070 A1
(43) Pub. Date: Jun. 18, 2026

(54) TRANSCEIVER DEVICE

(71) Applicant: Realtek Semiconductor Corporation, Hsinchu (TW)

(72) Inventors: Ping-Hsuan TSAI, Hsinchu (TW); Po-Chih WANG, Hsinchu (TW); Chia-Jun CHANG, Hsinchu (TW)

(21) Appl. No.: 19/399,657

(22) Filed: Nov. 25, 2025

(30) Foreign Application Priority Data
Dec. 17, 2024 (TW) 113149229

(51) Int. Cl. H04B 1/408

(52) U.S. Cl. CPC H04B 1/408

(57) ABSTRACT

A transceiver device includes a transmitter circuit and a receiver circuit. The transmitter circuit is configured to couple an antenna and includes a first mixer and a first buffer circuit. The first mixer is configured to output a first radio frequency signal according to a first baseband signal and a first local oscillator signal. The first buffer circuit is configured to output the first local oscillator signal to the first mixer and includes a plurality of first buffers. The receiver circuit is configured to couple the antenna. A first buffers-coupled-in-parallel quantity of the first buffer circuit is adjusted according to an operation condition.

### RELATED APPLICATIONS

This application claims priority to Taiwanese Application Serial Number 113149229, filed Dec. 17, 2024, which is herein incorporated by reference.

### BACKGROUND

### Technical Field

The present disclosure relates to technology about a transceiver device. More particularly, the present disclosure relates to a transceiver device that can be adjusted according to an operation condition to maintain its performance.

### Description of Related Art

With development of technology, various electronic circuits are developed. For example, transceiver devices are developed with functions of transmitting signals and receiving signals. In some related approaches, a transceiver device can use a local oscillation signal to increase a frequency of a signal or decrease the frequency of the signal. However, stability of the local oscillation signal will affect performance of the transceiver device.

### SUMMARY

Some aspects of the present disclosure are to provide a transceiver device. The transceiver device includes a transmitter circuit and a receiver circuit. The transmitter circuit is configured to couple an antenna and includes a first mixer and a first buffer circuit. The first mixer is configured to output a first radio frequency signal according to a first baseband signal and a first local oscillator signal. The first buffer circuit is configured to output the first local oscillator signal to the first mixer and includes a plurality of first buffers. The receiver circuit is configured to couple the antenna. A first buffers-coupled-in-parallel quantity of the first buffer circuit is adjusted according to an operation condition.

Some aspects of the present disclosure are to provide a transceiver device. The transceiver device includes a transmitter circuit and a receiver circuit. The transmitter circuit is configured to couple an antenna and includes a first mixer and a first buffer circuit. The first mixer is configured to output a first radio frequency signal according to a first baseband signal and a first local oscillator signal. The first buffer circuit is configured to output the first local oscillator signal to the first mixer and includes a first buffer. The first buffer is configured to receive a first bias voltage and a second bias voltage. The receiver circuit is configured to couple the antenna. The first bias voltage and the second bias voltage are adjusted according to an operation condition.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a transceiver device according to some embodiments of the present disclosure.

FIG. 2A is a schematic diagram of a buffer circuit according to some embodiments of the present disclosure.

FIG. 2B is a schematic diagram of a buffer circuit according to some embodiments of the present disclosure.

FIG. 2C is a schematic diagram of a buffer circuit according to some embodiments of the present disclosure.

FIG. 3 is a schematic diagram of a buffer circuit according to some embodiments of the present disclosure.

FIG. 4 is a schematic diagram of a buffer circuit according to some embodiments of the present disclosure.

FIG. 5A is a schematic diagram of a buffer circuit according to some embodiments of the present disclosure.

FIG. 5B is a schematic diagram of a buffer circuit according to some embodiments of the present disclosure.

FIG. 5C is a schematic diagram of a buffer circuit according to some embodiments of the present disclosure.

### DETAILED DESCRIPTION

In the present disclosure, “connected” or “coupled” may refer to “electrically connected” or “electrically coupled.” “Connected” or “coupled” may also refer to operations or actions between two or more elements.

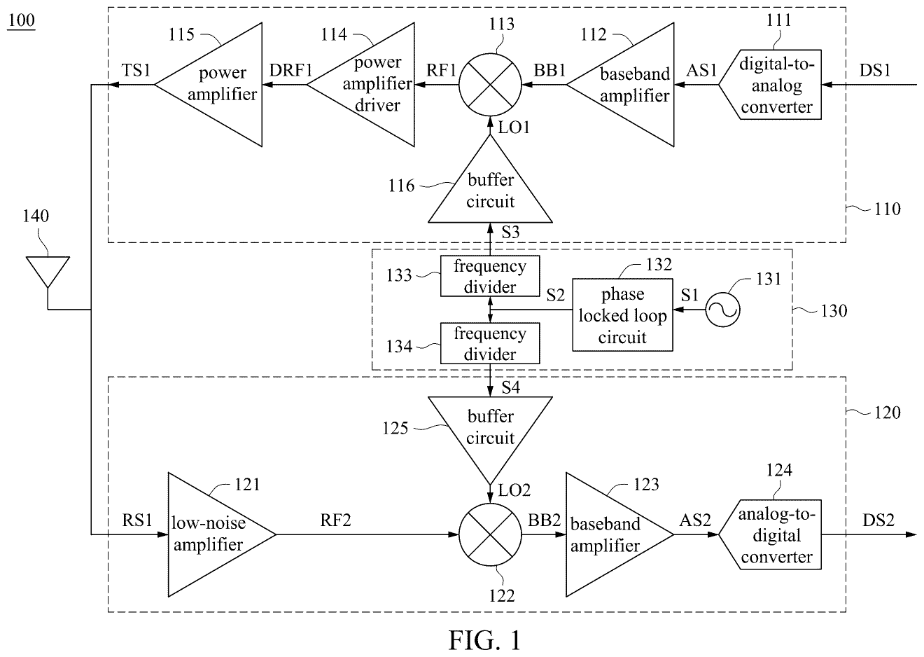

Reference is made to FIG. 1. FIG. 1 is a schematic diagram of a transceiver device 100 according to some embodiments of the present disclosure.

As illustrated in FIG. 1, the transceiver device 100 includes a transmitter circuit 110, a receiver circuit 120, an oscillator circuit 130, and an antenna 140. Regarding the coupling relationship, the transmitter circuit 110 and the receiver circuit 120 are coupled to the oscillator circuit 130. The transmitter circuit 110 is coupled to the antenna 140. The receiver circuit 120 is coupled to the antenna 140. In applications, the transceiver device 100 can transmit a transmitting signal TS1 through the antenna 140, or receive a receiving signal RS1 through the antenna 140.

The transmitter circuit 110 includes a digital-to-analog converter 111, a baseband amplifier 112, a mixer 113, a power amplifier driver 114, a power amplifier 115, and a buffer circuit 116.

The digital-to-analog converter 111 can receive a digital signal DS1 from a signal processor circuit or other circuits. The digital-to-analog converter 111 outputs an analog signal AS1 according to the digital signal DS1. The baseband amplifier 112 outputs a baseband signal BB1 according to the analog signal AS1. The mixer 113 outputs a radio frequency signal RF1 according to a baseband signal BB1 and a local oscillator signal LO1. The power amplifier driver 114 outputs a driving signal DRF1 according to the radio frequency signal RF1. The power amplifier 115 outputs the transmitting signal TS1 according to the driving signal DRF1. The transmitting signal TS1 is emitted through the antenna 140.

The receiver circuit 120 includes a low-noise amplifier 121, a mixer 122, a baseband amplifier 123, an analog-to-digital converter 124, and a buffer circuit 125.

The low-noise amplifier 121 can receive the receiving signal RS1 through the antenna 140. The low-noise amplifier 121 outputs a radio frequency signal RF2 according to the receiving signal RS1. The mixer 122 outputs a baseband signal BB2 according to the radio frequency signal RF2 and a local oscillator signal LO2. The baseband amplifier 123 outputs an amplified signal AS2 according to the baseband signal BB2. The analog-to-digital converter 124 outputs a digital signal DS2 according to the amplified signal AS2. The digital signal DS2 can be outputted to the aforementioned signal processor circuit or other circuits.

The oscillator circuit 130 includes a voltage controlled oscillator 131, a phase locked loop circuit 132, a frequency divider 133, and a frequency divider 134.

The voltage controlled oscillator 131 outputs a signal S1. The phase locked loop circuit 132 outputs a signal S2 according to the signal S1. The frequency divider 133 output a signal S3 to the buffer circuit 116 according to the signal S2. The frequency divider 134 outputs a signal S4 to a buffer circuit 125 according to the signal S2.

The buffer circuit 116 outputs the local oscillator signal LO1 to the mixer 113 according to the signal S3. The buffer circuit 125 outputs the local oscillator signal LO2 to the mixer 122 according to the signal S4.

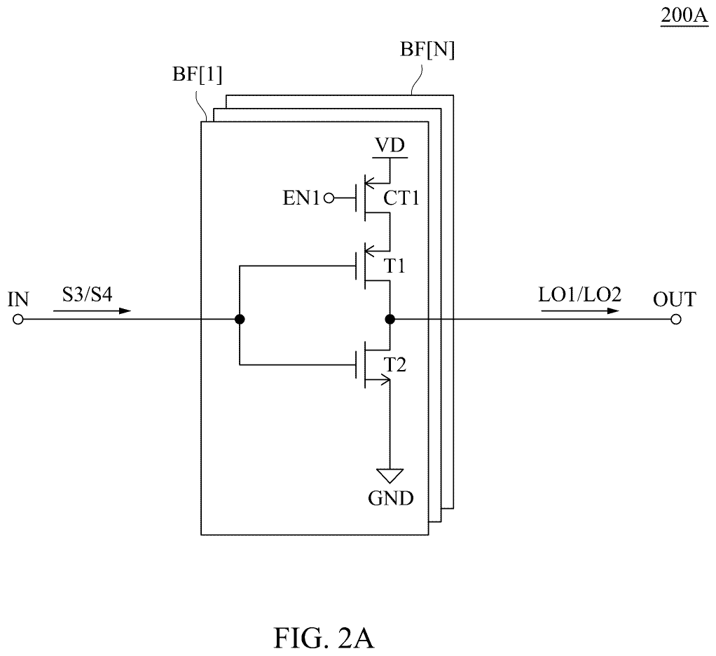

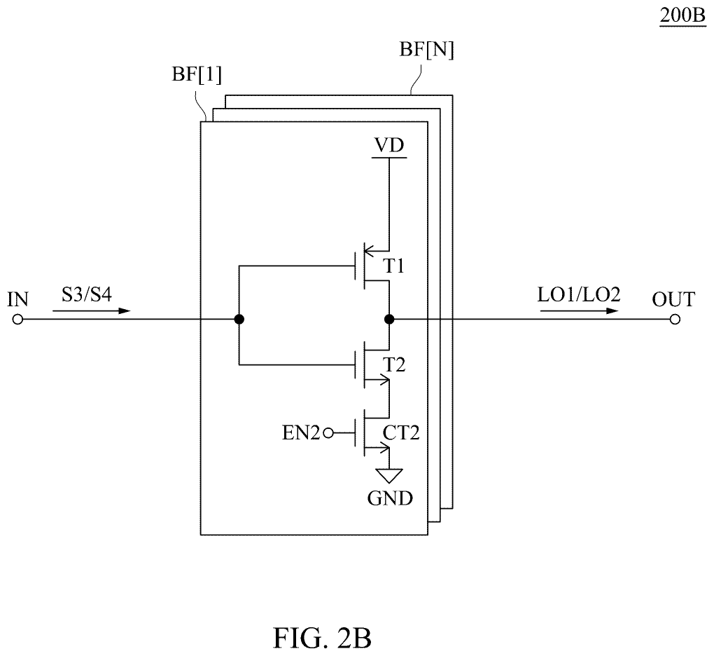

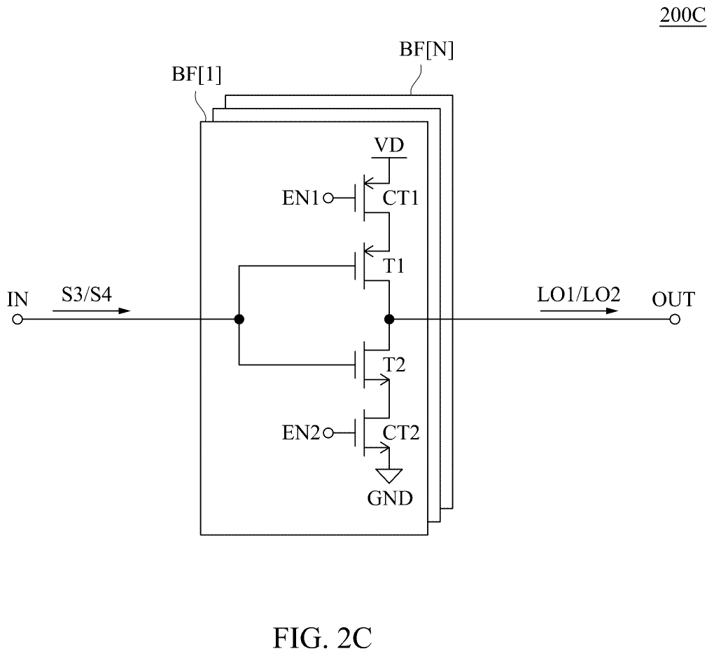

References are made to FIG. 1 and FIG. 2A. FIG. 2A is a schematic diagram of a buffer circuit 200A according to some embodiments of the present disclosure.

As illustrated in FIG. 2A, the buffer circuit 200A includes a plurality of buffers BF[1]-BF[N] and the buffers BF[1]-BF[N] can be controlled to be coupled in parallel between an input terminal IN and an output terminal OUT.

In some embodiments, the buffer circuit 116 or the buffer circuit 125 can be implemented by the buffer circuit 200A. When the buffer circuit 116 is implemented by the buffer circuit 200A, the buffer circuit 116 includes the buffers BF[1]-BF[N], receives the signal S3 through the input terminal IN, and outputs the local oscillator signal LO1 through the output terminal OUT. When the buffer circuit 125 is implemented by the buffer circuit 200A, the buffer circuit 125 includes the buffers BF[1]-BF[N], receives the signal S4 through the input terminal IN, and outputs the local oscillator signal LO2 through the output terminal OUT.

Taking the buffer BF[1] as an example, the buffer BF[1] includes a transistor T1, a transistor T2, and a control transistor CT1. The transistor T1 is coupled between a power terminal VD and the output terminal OUT. A control terminal (e.g., a gate terminal) of the transistor T1 is coupled to the input terminal IN. The transistor T2 is coupled between the output terminal OUT and a ground terminal GND. A control terminal (e.g., a gate terminal) of the transistor T2 is coupled to the input terminal IN. The control transistor CT1 is coupled between the transistor T1 and the power terminal VD and is controlled by a control signal EN1 to be turned on or off. For example, when the control signal EN1 has a low logic value, the control transistor CT1 is turned on. At this time, the buffer BF[1] is in a turned-on state. When the control signal EN1 has a high logic value, the control transistor CT1 is turned off. At this time, the buffer BF[1] is in a turned-off state. In the example of FIG. 2A, the transistor T1 and the control transistor CT1 are implemented by P-type transistors, the transistor T2 is implemented by an N-type transistor, but the present disclosure is not limited thereto.

Other buffers in the buffer circuit 200A have the same circuit structure, but the control transistors CT1 in other buffers can be controlled by other control signals to be turned on or off. By these control signals, the buffers can be controlled to be in the turned-on state or in the turned-off state respectively to further adjust (e.g., increase or decrease) the buffers-coupled-in-parallel quantity of the buffer circuit 200A. For example, when M buffers are in the turned-on state in the buffer circuit 200A, the buffers-coupled-in-parallel quantity of the buffer circuit 200A is M.

In some related approaches, a transceiver device uses a single buffer to output a local oscillator signal to a mixer. However, operation conditions will significantly affect the amplitude of the local oscillator signal outputted from this single buffer, thereby affecting the performance of the transceiver device.

Compared to the aforementioned related approaches, in the present disclosure, the buffers-coupled-in-parallel quantity of the buffer circuit 200A can be adjusted according to an operation condition. By adjusting the buffers-coupled-in-parallel quantity of the buffer circuit 200A (or a buffer circuit 200B in FIG. 2B, or a buffer circuit 200C in FIG. 2C), the amplitude of the local oscillator signal LO1 or the local oscillator signal LO2 can be maintained constant or almost constant so as to maintain the performance of the transceiver device 100.

The aforementioned operation conditions can be, for example, environmental conditions or process conditions. The environmental conditions can be, for example, an operation frequency or an operation temperature. The process conditions can be, for example, a transistor speed.

Taking the buffer circuit 200A as an example, in some embodiments, when the operation frequency increases, a controller can output the aforementioned control signals to the buffers BF[1]-BF[N] in the buffer circuit 200A such that the buffers-coupled-in-parallel quantity of the buffer circuit 200A increases. When the operation frequency decreases, the controller can output the aforementioned control signals to the buffers BF[1]-BF[N] in the buffer circuit 200A such that the buffers-coupled-in-parallel quantity of the buffer circuit 200A decreases. When the operation temperature increases, the controller can output the aforementioned control signals to the buffers BF[1]-BF[N] in the buffer circuit 200A such that the buffers-coupled-in-parallel quantity of the buffer circuit 200A increases. When the operation temperature decreases, the controller can output the aforementioned control signals to the buffers BF[1]-BF[N] in the buffer circuit 200A such that the buffers-coupled-in-parallel quantity of the buffer circuit 200A decreases. When the transistor speed is lower than a first threshold value (slower), the controller can output the aforementioned control signals to the buffers BF[1]-BF[N] in the buffer circuit 200A such that the buffers-coupled-in-parallel quantity of the buffer circuit 200A increases. When the transistor speed is higher than a second threshold value (faster), the controller can output the aforementioned control signals to the buffers BF[1]-BF[N] in the buffer circuit 200A such that the buffers-coupled-in-parallel quantity of the buffer circuit 200A decreases. In some embodiments, the second threshold value is higher than the first threshold value.

Reference is made to FIG. 2B. FIG. 2B is a schematic diagram of a buffer circuit 200B according to some embodiments of the present disclosure.

As illustrated in FIG. 2B, the buffer circuit 200B includes a plurality of buffers BF[1]-BF[N] and the buffers BF[1]-BF[N] can be controlled to be coupled in parallel between an input terminal IN and an output terminal OUT. In some embodiments, the buffer circuit 116 or the buffer circuit 125 in FIG. 1 can be implemented by the buffer circuit 200B.

Taking the buffer BF[1] as an example, the buffer BF[1] includes a transistor T1, a transistor T2, and a control transistor CT1. The transistor T1 is coupled between a power terminal VD and the output terminal OUT. A control terminal of the transistor T1 is coupled to the input terminal IN. The transistor T2 is coupled between the output terminal OUT and a ground terminal GND. A control terminal of the transistor T2 is coupled to the input terminal IN. The control transistor CT2 is coupled between the transistor T2 and the ground terminal GND and is controlled by a control signal EN2 to be turned on or off. For example, when the control signal EN2 has a high logic value, the control transistor CT2 is turned on. At this time, the buffer BF[1] is in the turned-on state. When the control signal EN2 has a low logic value, the control transistor CT2 is turned off. At this time, the buffer BF[1] is in the turned-off state. In the example of FIG. 2B, the transistor T1 is implemented by a P-type transistor, the transistor T2 and the control transistor CT2 are implemented by N-type transistors, but the present disclosure is not limited thereto.

Other buffers in the buffer circuit 200B have the same circuit structure, but the control transistors CT2 in other buffers can be controlled by other control signals to be turned on or off. By these control signals, the buffers can be controlled to be in the turned-on state or in the turned-off state respectively to further adjust (e.g., increase or decrease) the buffers-coupled-in-parallel quantity of the buffer circuit 200B.

How to adjust the buffers-coupled-in-parallel quantity of the buffer circuit 200B according to the operation conditions (e.g., the environmental conditions or the process conditions) is similar to that of the buffer circuit 200A, so it is not described herein again.

Reference is made to FIG. 2C. FIG. 2C is a schematic diagram of a buffer circuit 200C according to some embodiments of the present disclosure.

As illustrated in FIG. 2C, the buffer circuit 200C includes a plurality of buffers BF[1]-BF[N] and the buffers BF[1]-BF[N] can be controlled to be coupled in parallel between an input terminal IN and an output terminal OUT. In some embodiments, the buffer circuit 116 or the buffer circuit 125 in FIG. 1 can be implemented by the buffer circuit 200C.

Taking the buffer BF[1] as an example, the buffer BF[1] includes a transistor T1, a transistor T2, a control transistor CT1, and a control transistor CT2. The transistor T1 is coupled between a power terminal VD and the output terminal OUT. A control terminal of the transistor T1 is coupled to the input terminal IN. The transistor T2 is coupled between the output terminal OUT and a ground terminal GND. A control terminal of the transistor T2 is coupled to the input terminal IN. The control transistor CT1 is coupled between the transistor T1 and the power terminal VD and is controlled by a control signal EN1 to be turned on or off. The control transistor CT2 is coupled between the transistor T2 and the ground terminal GND and is controlled by a control signal EN2 to be turned on or off. For example, when the control signal EN1 has a low logic value and the control signal EN2 has a high logic value, the control transistor CT1 and the control transistor CT2 are turned on. At this time, the buffer BF[1] is in a turned-on state. When the control signal EN1 has the high logic value or the control signal EN2 has the low logic value, the control transistor CT1 or the control transistor CT2 is turned off. At this time, the buffer BF[1] is in a turned-off state. In the example of FIG. 2C, the transistor T1 and the control transistor CT1 are implemented by P-type transistors, the transistor T2 and the control transistor CT2 are implemented by N-type transistors, but the present disclosure is not limited thereto.

Other buffers in the buffer circuit 200C have the same circuit structure, but the control transistors CT1 or the control transistors CT2 in other buffers can be controlled by other control signals to be turned on or off. By these control signals, the buffers can be controlled to be in the turned-on state or in the turned-off state respectively to further adjust (e.g., increase or decrease) the buffers-coupled-in-parallel quantity of the buffer circuit 200C.

How to adjust the buffers-coupled-in-parallel quantity of the buffer circuit 200C according to the operation conditions (e.g., the environmental conditions or the process conditions) is similar to that of the buffer circuit 200A, so it is not described herein again.

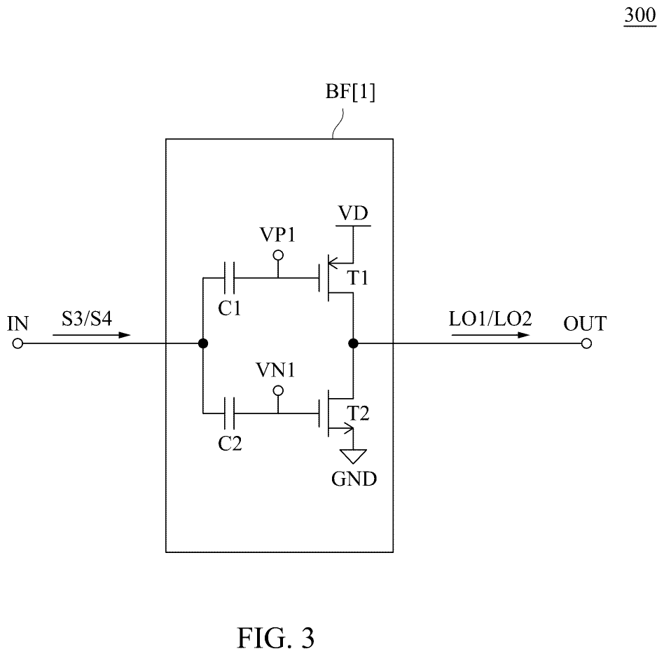

Reference is made to FIG. 3. FIG. 3 is a schematic diagram of a buffer circuit 300 according to some embodiments of the present disclosure.

As illustrated in FIG. 3, the buffer circuit 300 includes a buffer BF[1] and the buffer BF[1] is coupled in parallel between an input terminal IN and an output terminal OUT. In some embodiments, the buffer circuit 116 or the buffer circuit 125 in FIG. 1 can be implemented by the buffer circuit 300. The buffer circuit 300 receives a bias voltage VP1 and a bias voltage VN1.

The buffer BF[1] includes a transistor T1, a transistor T2, a capacitor C1, and a capacitor C2. The transistor T1 is coupled between a power terminal VD and the output terminal OUT. A control terminal of the transistor T1 is coupled to the input terminal IN. The transistor T2 is coupled between the output terminal OUT and a ground terminal GND. A control terminal of the transistor T2 is coupled to the input terminal IN. The capacitor C1 is coupled between the input terminal IN and the control terminal of the transistor T1. The capacitor C2 is coupled between the input terminal IN and the control terminal of the transistor T2. The capacitor C1 and the capacitor C2 are configured to isolate direct current (DC) components. In some other embodiments, it can be designed without the capacitor C1 and the capacitor C2. The control terminal of the transistor T1 receives the bias voltage VP1. The control terminal of the transistor T2 receives the bias voltage VN1. In the example of FIG. 3, the transistor T1 is implemented by a P-type transistor, the transistor T2 is implemented by an N-type transistor, but the present disclosure is not limited thereto.

As described above, the operation conditions will significantly affect the amplitude of the local oscillator signal outputted from the single buffer, thereby affecting the performance of the transceiver device.

In the present disclosure, the bias voltage VP1 and the bias voltage VN1 can be adjusted according to the operation conditions. By adjusting the bias voltage VP1 and the bias voltage VN1, the amplitude of the local oscillator signal LO1 or the local oscillator signal LO2 can be maintained constant or almost constant so as to maintain the performance of the transceiver device 100.

The aforementioned operation conditions can be, for example, environmental conditions or process conditions. The environmental conditions can be, for example, an operation frequency or an operation temperature. The process conditions can be, for example, a transistor speed.

Taking the buffer circuit 300 as an example, in some embodiments, when the operation frequency increases, a controller can increase the bias voltage VN1 and decrease the bias voltage VP1. When the operation frequency decreases, a controller can decrease the bias voltage VN1 and increase the bias voltage VP1. When the operation temperature increases, the controller can increase the bias voltage VN1 and decrease the bias voltage VP1. When the operation temperature decreases, the controller can decrease the bias voltage VN1 and increase the bias voltage VP1. When the transistor speed is lower than a first threshold value (slower), the controller can increase the bias voltage VN1 and decrease the bias voltage VP1. When the transistor speed is higher than a second threshold value (faster), the controller can decrease the bias voltage VN1 and increases the bias voltage VP1. In some embodiments, the second threshold value is higher than the first threshold value.

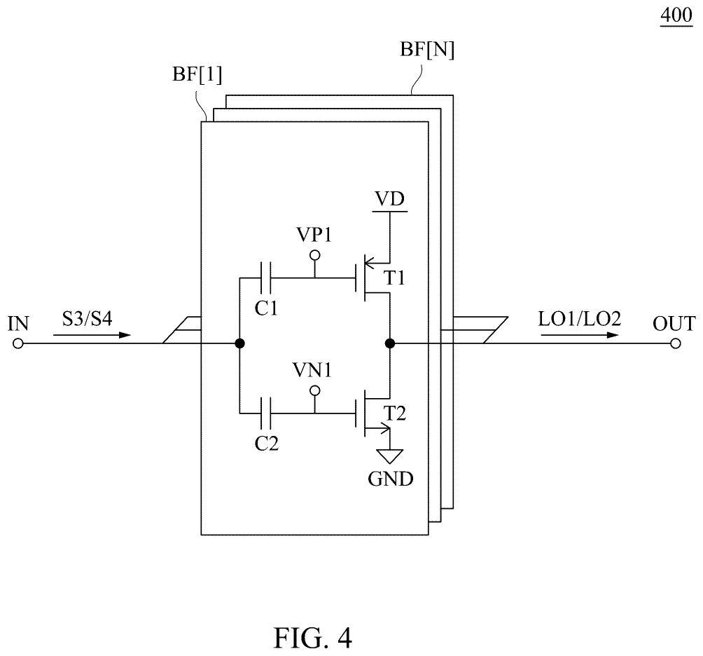

Reference is made to FIG. 4. FIG. 4 is a schematic diagram of a buffer circuit 400 according to some embodiments of the present disclosure.

As illustrated in FIG. 4, the buffer circuit 400 includes a plurality of buffers BF[1]-BF[N] and the buffers BF[1]-BF[N] can be controlled to be coupled in parallel between an input terminal IN and an output terminal OUT. In some embodiments, the buffer circuit 116 or the buffer circuit 125 in FIG. 1 can be implemented by the buffer circuit 400.

The circuit structure of the buffer BF[1] in FIG. 4 is the same to the circuit structure of the buffer BF[1] in FIG. 3, so it is not described herein again.

Other buffers in the buffer circuit 400 have the same circuit structure, but the transistors T1 and the transistors T2 in other buffers can be controlled by other bias voltages. In addition to directly affecting the amplitude of the local oscillator signal LO1 or the local oscillator signal LO2, these bias voltages can further change the buffers-coupled-in-parallel quantity of the buffer circuit 400 to further affect the amplitude of the local oscillator signal LO1 or the local oscillator signal LO2. For example, when the bias voltage VP1 is equal to the power voltage of the power terminal VD, the transistor T1 is turned off. At this time, the buffer BF[1] is in the turned-off state. When the bias voltage VN1 is equal to the ground voltage of the ground terminal GND, the transistor T2 is turned off. At this time, the buffer BF[1] is in the turned-off state.

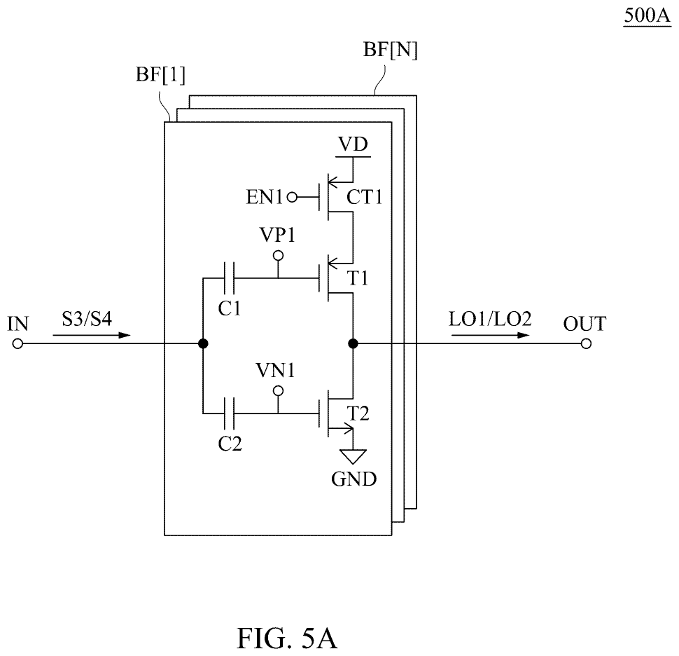

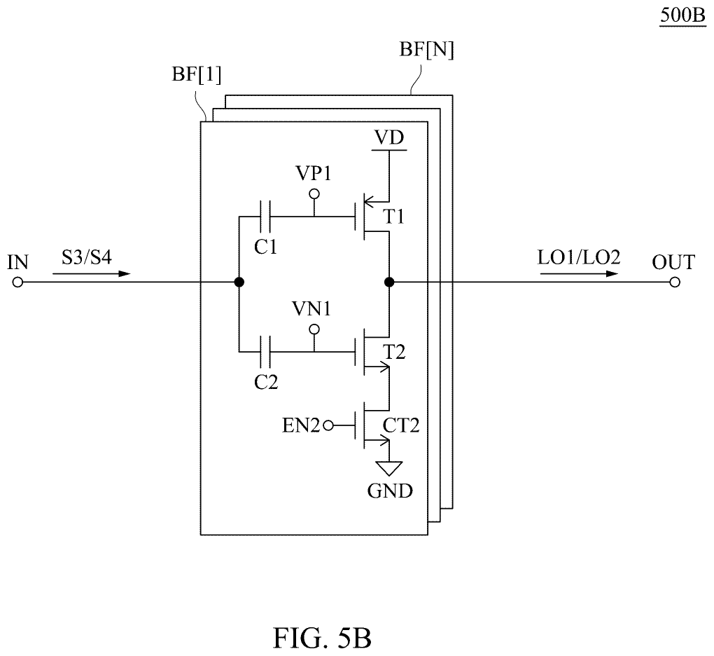

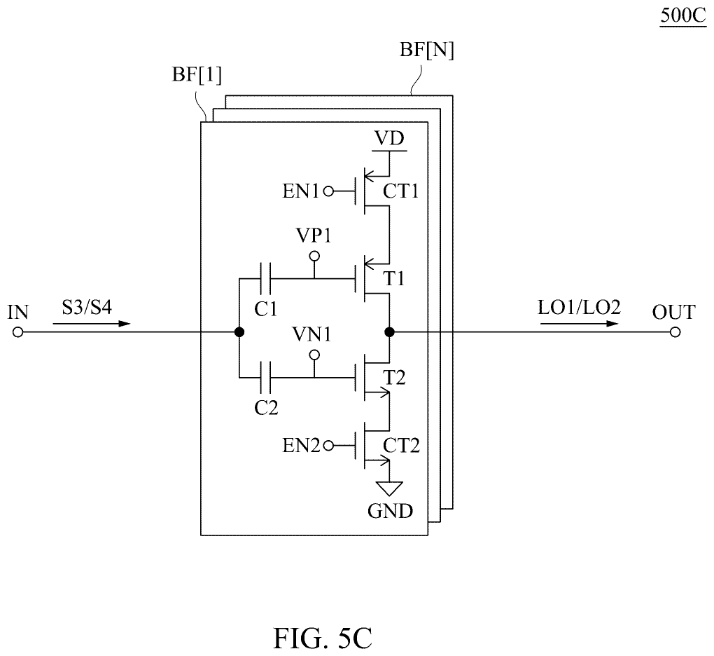

Reference is made to FIG. 5A. FIG. 5A is a schematic diagram of a buffer circuit 500A according to some embodiments of the present disclosure.

As illustrated in FIG. 5A, the buffer circuit 500A includes a plurality of buffers BF[1]-BF[N] and the buffers BF[1]-BF[N] can be controlled to be coupled in parallel between an input terminal IN and an output terminal OUT. In some embodiments, the buffer circuit 116 or the buffer circuit 125 in FIG. 1 can be implemented by the buffer circuit 500A.

The circuit structure of the buffer BF[1] in FIG. 5A is similar to the circuit structure of the buffer BF[1] in FIG. 2A. A major difference between them is that, in FIG. 5A, the control terminal of the transistor T1 receives the bias voltage VP1, the control terminal of the transistor T2 receives the bias voltage VN1, and the buffer BF[1] further includes the capacitor C1 and the capacitor C2. As described above, in some other embodiments, it can be designed without the capacitor C1 and the capacitor C2.

Other buffers in the buffer circuit 500A have the same circuit structure. However, the control transistors CT1 in other buffers can be controlled by other control signals to be turned on or off, and the transistors T1 and the transistors T2 in other buffers can be controlled by other bias voltages.

Reference is made to FIG. 5B. FIG. 5B is a schematic diagram of a buffer circuit 500B according to some embodiments of the present disclosure.

As illustrated in FIG. 5B, the buffer circuit 500B includes a plurality of buffers BF[1]-BF[N] and the buffers BF[1]-BF[N] can be controlled to be coupled in parallel between an input terminal IN and an output terminal OUT. In some embodiments, the buffer circuit 116 or the buffer circuit 125 in FIG. 1 can be implemented by the buffer circuit 500B.

The circuit structure of the buffer BF[1] in FIG. 5B is similar to the circuit structure of the buffer BF[1] in FIG. 2B. A major difference between them is that, in FIG. 5B, the control terminal of the transistor T1 receives the bias voltage VP1, the control terminal of the transistor T2 receives the bias voltage VN1, and the buffer BF[1] further includes the capacitor C1 and the capacitor C2. As describe above, in some other embodiments, it can be designed without the capacitor C1 and the capacitor C2.

Other buffers in the buffer circuit 500B have the same circuit structure. However, the control transistors CT2 in other buffers can be controlled by other control signals to be turned on or off, and the transistors T1 and the transistors T2 in other buffers can be controlled by other bias voltages.

Reference is made to FIG. 5C. FIG. 5C is a schematic diagram of a buffer circuit 500C according to some embodiments of the present disclosure.

As illustrated in FIG. 5C, the buffer circuit 500C includes a plurality of buffers BF[1]-BF[N] and the buffers BF[1]-BF[N] can be controlled to be coupled in parallel between an input terminal IN and an output terminal OUT. In some embodiments, the buffer circuit 116 or the buffer circuit 125 in FIG. 1 can be implemented by the buffer circuit 500C.

The circuit structure of the buffer BF[1] in FIG. 5C is similar to the circuit structure of the buffer BF[1] in FIG. 2C. A major difference between them is that, in FIG. 5C, the control terminal of the transistor T1 receives the bias voltage VP1, the control terminal of the transistor T2 receives the bias voltage VN1, and the buffer BF[1] further includes the capacitor C1 and the capacitor C2. As described above, in some other embodiments, it can be designed without the capacitor C1 and the capacitor C2.

Other buffers in the buffer circuit 500C have the same circuit structure. However, the control transistors CT1 and the control transistors CT2 in other buffers can be controlled by other control signals to be turned on or off, and the transistors T1 and the transistors T2 in other buffers can be controlled by other bias voltages.

As described above, in the transceiver device in the present disclosure, the buffers-coupled-in-parallel quantity or the bias voltages inputted into the buffers can be adjusted according to the operation conditions (e.g., the environmental conditions or the process conditions) such that the amplitude of the local oscillator signal can be maintained constant or almost constant so as to maintain the performance of the transceiver device.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A transceiver device, comprising:
a transmitter circuit configured to couple an antenna and comprising:
a first mixer configured to output a first radio frequency signal according to a first baseband signal and a first local oscillator signal; and
a first buffer circuit configured to output the first local oscillator signal to the first mixer and comprising a plurality of first buffers; and
a receiver circuit configured to couple the antenna,
wherein a first buffers-coupled-in-parallel quantity of the first buffer circuit is adjusted according to an operation condition.

2. The transceiver device of claim 1, wherein the operation condition is an operation frequency,
wherein when the operation frequency increases, the first buffers-coupled-in-parallel quantity increases,
wherein when the operation frequency decreases, the first buffers-coupled-in-parallel quantity decreases.

3. The transceiver device of claim 1, wherein the operation condition is an operation temperature,
wherein when the operation temperature increases, the first buffers-coupled-in-parallel quantity increases,
wherein when the operation temperature decreases, the first buffers-coupled-in-parallel quantity decreases.

4. The transceiver device of claim 1, wherein the operation condition is a transistor speed,
wherein when the transistor speed is lower than a first threshold value, the first buffers-coupled-in-parallel quantity increases,
wherein when the transistor speed is higher than a second threshold value, the first buffers-coupled-in-parallel quantity decreases.

5. The transceiver device of claim 1, wherein one of the plurality of first buffers comprises:
a first transistor coupled between a power terminal and an output terminal, wherein a first control terminal of the first transistor is coupled to an input terminal; and
a second transistor coupled between the output terminal and a ground terminal, wherein a second control terminal of the second transistor is coupled to the input terminal.

6. The transceiver device of claim 5, wherein the first control terminal of the first transistor is configured to receive a first bias voltage, and the second control terminal of the second transistor is configured to receive a second bias voltage.

7. The transceiver device of claim 5, wherein the one of the plurality of first buffers further comprises:
a control transistor coupled between the first transistor and the power terminal, and controlled by a control signal to be turned on or off.

8. The transceiver device of claim 7, wherein the first control terminal of the first transistor is configured to receive a first bias voltage, and the second control terminal of the second transistor is configured to receive a second bias voltage.

9. The transceiver device of claim 5, wherein the one of the plurality of first buffers further comprises:
a control transistor coupled between the second transistor and the ground terminal, and controlled by a control signal to be turned on or off.

10. The transceiver device of claim 9, wherein the first control terminal of the first transistor is configured to receive a first bias voltage, and the second control terminal of the second transistor is configured to receive a second bias voltage.

11. The transceiver device of claim 5, wherein the one of the plurality of first buffers further comprises:
a first control transistor coupled between the first transistor and the power terminal, and controlled by a first control signal to be turned on or off; and
a second control transistor coupled between the second transistor and the ground terminal, and controlled by a second control signal to be turned on or off.

12. The transceiver device of claim 11, wherein the first control terminal of the first transistor is configured to receive a first bias voltage, and the second control terminal of the second transistor is configured to receive a second bias voltage.

13. The transceiver device of claim 1, wherein the receiver circuit comprises:
a second mixer configured to output a second baseband signal according to a second radio frequency signal and a second local oscillator signal; and
a second buffer circuit configured to output the second local oscillator signal to the second mixer and comprising a plurality of second buffers,
wherein a second buffers-coupled-in-parallel quantity of the second buffer circuit is adjusted according to the operation condition.

14. A transceiver device, comprising:
a transmitter circuit configured to couple an antenna and comprising:
a first mixer configured to output a first radio frequency signal according to a first baseband signal and a first local oscillator signal; and
a first buffer circuit configured to output the first local oscillator signal to the first mixer and comprising a first buffer, wherein the first buffer is configured to receive a first bias voltage and a second bias voltage; and
a receiver circuit configured to couple the antenna,
wherein the first bias voltage and the second bias voltage are adjusted according to an operation condition.

15. The transceiver device of claim 14, wherein the first buffer comprises:
a first transistor coupled between a power terminal and an output terminal, wherein a first control terminal of the first transistor is coupled to an input terminal and configured to receive the first bias voltage; and
a second transistor coupled between the output terminal and a ground terminal, wherein a second control terminal of the second transistor is coupled to the input terminal and configured to receive the second bias voltage.

16. The transceiver device of claim 15, wherein the first buffer further comprises:
a first capacitor coupled between the input terminal and the first control terminal of the first transistor; and
a second capacitor coupled between the input terminal and the second control terminal of the second transistor.

17. The transceiver device of claim 15, wherein the operation condition is an operation frequency,
wherein when the operation frequency increases, the first bias voltage increases and the second bias voltage decreases,
wherein when the operation frequency decreases, the first bias voltage decreases and the second bias voltage increases.

18. The transceiver device of claim 15, wherein the operation condition is an operation temperature,
wherein when the operation temperature increases, the first bias voltage increases and the second bias voltage decreases,
wherein when the operation temperature decreases, the first bias voltage decreases and the second bias voltage increases.

19. The transceiver device of claim 15, wherein the operation condition is a transistor speed,
wherein when the transistor speed is lower than a first threshold value, the first bias voltage increases and the second bias voltage decreases,
wherein when the transistor speed is higher than a second threshold value, the first bias voltage decreases and the second bias voltage increases.

20. The transceiver device of claim 14, wherein the receiver circuit comprises:
a second mixer configured to output a second baseband signal according to a second radio frequency signal and a second local oscillator signal; and
a second buffer circuit configured to output the second local oscillator signal to the second mixer and comprising a second buffer, wherein the second buffer is configured to receive a third bias voltage and a fourth bias voltage,
wherein the third bias voltage and the fourth bias voltage are adjusted according to the operation condition.
